(19) United States
(12) Patent Application Publication
(10) Pub. No.: US 2020/0220932 A1
(43) Pub. Date: Jul. 9, 2020

(54) METHOD OF REMOTELY INITIATING A ROUTINE EVENT OF AN APPLIANCE

(71) Applicant: Haier US Appliance Solutions, Inc., Wilmington, DE (US)

(72) Inventors: William Everette Gardner, Louisville, KY (US); Arnold Estravillo, Mt. Washington, KY (US); Irena J. McDowell, Louisville, KY (US); Jeff Donald Drake, Louisville, KY (US); Chad Michael Helms, Louisville, KY (US)

(21) Appl. No.: 16/240,844

(22) Filed: Jan. 7, 2019

(51) Int. Cl. H04L 29/08; G05D 23/19; G05B 19/048; H04W 4/02

(52) U.S. Cl. CPC H04L 67/125; H04L 67/22; G05D 23/1917; G06N 20/00; H04W 4/025; G05B 2219/2654; G05B 19/048

(57) ABSTRACT

A method of using a remote server to operate an appliance includes an appliance sending data indicative of usage patterns of the appliance to a remote server. The remote server identifies a routine event based on the data and sends an event initiation prompt including operational data related to the routine event to the appliance or a user of the appliance. The user may confirm that the routine should be initiated, and such confirmation may be communicated to the appliance before the appliance initiates the routine event.

### FIELD OF THE INVENTION

The present subject matter relates generally to appliances, and more particularly, to systems and methods for identifying and initiating routine events in such appliances.

### BACKGROUND OF THE INVENTION

Refrigerator appliances can include a dispensing assembly for directing ice from the refrigerator's ice maker and/or liquid water to the dispensing assembly. A user can activate the dispensing assembly to direct a flow of ice or liquid water into a cup or other container positioned within the dispensing assembly. Liquid water directed to the dispensing assembly is generally chilled or at an ambient temperature. However, certain refrigerator appliances also include features for dispensing heated liquid water that can be used to make hot beverages, such as coffee or tea.

Notably, the use of hot water for use in preparing meals and/or beverages may be a very routine event. In this regard, for example, an appliance user may eat breakfast at the same time each morning and desire that a specific volume and temperature of hot water be prepared for use at that time. However, heating water in a refrigerator is not instantaneous, and certain dispensers take several minutes for the water to reach the target temperature. Therefore, a user may have to waste time waiting for the water to heat, resulting in general dissatisfaction with the appliance. Certain appliances have features permitting a user to set predefined schedules for performing particular tasks such as heating water, but such schedules may be rigid and difficult to program.

Accordingly, a refrigerator appliance that includes improved features for heating water would be useful. More specifically, a dispensing assembly for a refrigerator appliance that heats water to the desired temperature without delaying a user of the appliance would be particularly beneficial.

### BRIEF DESCRIPTION OF THE INVENTION

Aspects and advantages of the invention will be set forth in part in the following description, or may be apparent from the description, or may be learned through practice of the invention.

In accordance with one embodiment, a method of using a remote server to operate an appliance is provided. The method includes receiving data indicative of usage patterns of the appliance, identifying a routine event based on the data indicative of usage patterns, and sending an event initiation prompt including operational data related to the routine event to the appliance or a user of the appliance.

In accordance with another embodiment, a method of operating an appliance is provided. The method includes obtaining data indicative of usage patterns of the appliance, communicating the data indicative of usage patterns to a remote server, receiving an event initiation prompt including operational data related to a routine event from the remote server or a user of the appliance, and initiating the routine event in response to receiving the event initiation prompt.

According to still another embodiment, a refrigerator appliance is provided including a cabinet defining a chilled chamber, a door being rotatably hinged to the cabinet to provide selective access to the chilled chamber, the door defining a dispenser recess, and a dispensing assembly positioned within the dispenser recess for providing a flow of water and a heating assembly for heating the flow of water. A controller is operably coupled to the dispensing assembly for obtaining data indicative of usage patterns of the dispensing assembly of the refrigerator appliance, communicating the data indicative of usage patterns to a remote server, receiving an event initiation prompt including operational data related to a routine event of the dispensing assembly, and initiating the routine event in response to receiving the event initiation prompt.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a refrigerator appliance according to an exemplary embodiment of the present subject matter.

FIG. 2 provides a front view of a dispensing assembly of the exemplary refrigerator appliance of FIG. 1.

FIG. 3 depicts certain components of a controller according to example embodiments of the present subject matter.

FIG. 4 is a schematic diagram of an external communication system that may be used with the exemplary refrigerator appliance of FIG. 1 according to an exemplary embodiment of the present subject matter.

FIG. 5 provides a method for using a remote server to identify and initiate a routine event of a refrigerator appliance according to an exemplary embodiment of the present subject matter.

FIG. 6 provides a method for operating an appliance to perform a routine event according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

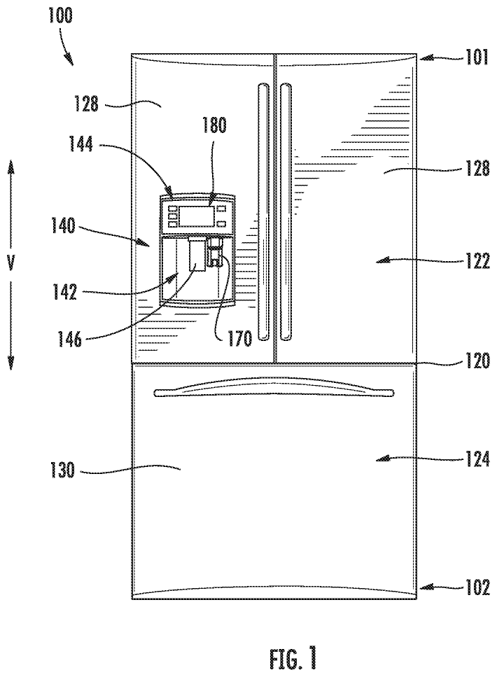

FIG. 1 provides a front, elevation view of a refrigerator appliance 100 according to an exemplary embodiment of the present subject matter. Refrigerator appliance 100 includes a cabinet or housing 120. Housing 120 extends between an upper portion 101 and a lower portion 102 along a vertical direction V. Housing 120 defines chilled chambers, e.g., a fresh food compartment 122 positioned adjacent upper portion 101 of housing 120 and a freezer compartment 124 arranged at lower portion 102 of housing 120. Housing 120 also defines a mechanical compartment (not shown) for receipt of a sealed cooling system for cooling fresh food compartment 122 and freezer compartment 124.

Refrigerator appliance 100 is generally referred to as a bottom-mount refrigerator appliance. However, it should be understood that refrigerator appliance 100 is provided by way of example only. Thus, the present subject matter is not limited to refrigerator appliance 100 and may be utilized in any suitable refrigerator appliance. For example, one of skill in the art will understand that the present subject matter may be used with side-by-side style refrigerator appliances or top-mount refrigerator appliances as well. Moreover, aspects of the present subject matter may be used to identify and initiate routine events, tasks, and/or operating cycles of any appliance.

Refrigerator doors 128 are rotatably hinged to housing 120 proximate fresh food compartment 122 in order to permit selective access to fresh food compartment 122. A freezer door 130 is arranged below refrigerator doors 128 for accessing freezer compartment 124. Freezer door 130 is mounted to a freezer drawer (not shown) slidably coupled within freezer compartment 124.

Refrigerator appliance 100 may also include a dispensing assembly 140 for dispensing various fluids, such as liquid water and/or ice, to a dispenser recess 142 defined on one of refrigerator doors 128. Dispensing assembly 140 includes a dispenser 144 positioned on an exterior portion of refrigerator appliance 100, for example, within dispenser recess 142. Dispenser 144 includes several outlets for accessing ice, chilled liquid water, and heated liquid water. To access ice, chilled liquid water, and heated liquid water, water-dispensing assembly 140 may for example include a paddle 146 mounted below a chilled water outlet 150, an ice outlet 152, and a heated water outlet 154.

To operate dispensing assembly 140, a user can urge a vessel, such as a cup, against paddle 146 to initiate a flow of chilled liquid water, heated liquid water and/or ice into the vessel within dispenser recess 142. Outlets 150, 152, and 154 and paddle 146 may be an external part of dispenser 144, and are positioned at or adjacent dispenser recess 142, e.g., a concave portion defined in an outside surface of refrigerator door 128. Dispenser 144 is positioned at a predetermined elevation convenient for a user to access ice or liquid water, e.g., enabling the user to access ice without the need to bend-over and without the need to access freezer compartment 124. In the exemplary embodiment, dispenser 144 is positioned at a level that approximates the chest level of a user.

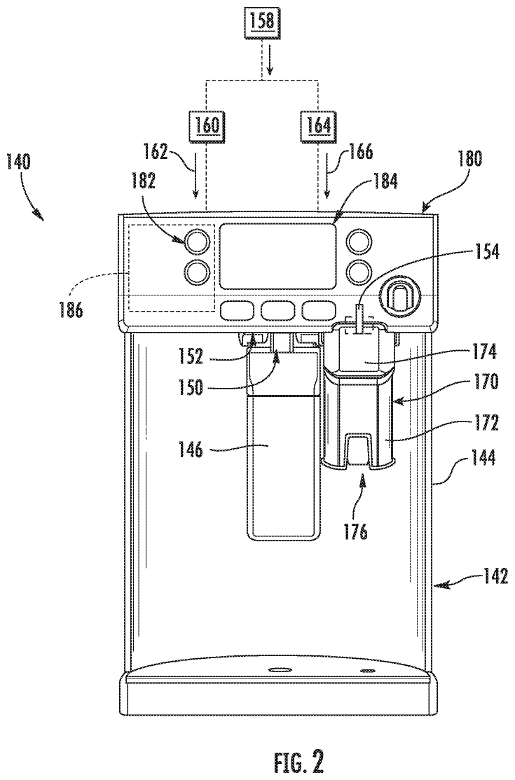

Refrigerator appliance 100 also includes features for generating heated liquid water and directing such heated liquid water to dispenser 144. Thus, refrigerator appliance 100 need not be connected to a residential hot water heating system in order to supply heated liquid water to dispenser 144. In this regard, as shown for example in FIG. 2, dispensing assembly 140 may be in fluid communication with a water supply source 158, such as a municipal water supply for receiving a flow of water. A sealed system 160 may be used to chill water from water supply source 158, e.g., to provide a flow of chilled water (as indicated by reference numeral 162) which may be dispensed through chilled water outlet 150. In addition, refrigerator appliance 100 may include a heating element or a heating assembly 164 which heats water to provide a flow of heated water (as indicated by reference numeral 166). According to exemplary embodiments, features of such heating assembly 164 may include, for example, a variety of water supplies, hot water tanks, heating elements, temperature sensors, and control valves to heat water from a well or municipal water supply, store the heated water, and supply the heated water to dispenser 144.

Dispensing assembly 140 is preferably capable of providing heated water at various temperatures depending on the type of beverage being brewed. For example, when brewing ground coffee, water for brewing is preferably heated to between one hundred and eighty degrees Fahrenheit and one hundred and ninety degrees Fahrenheit. However, according to alternative embodiments, dispensing assembly 140 may be adjusted to provide water for making beverages at any suitable temperature.

Referring now generally to FIG. 2, dispensing assembly 140 includes a brew module 170 according to an exemplary embodiment of the present subject matter. Brew module 170 is mountable within dispenser recess 142 such that brew module 170 is in fluid communication with hot water outlet 154 when mounted within dispenser recess 142. Thus, the flow of heated water 166 from hot water outlet 154 may flow into brew module 170. As illustrated, brew module 170 may include a body 172 that defines a brew chamber for receiving a brew pod (not shown). A lid 174 is pivotally attached to body 172 with a hinge to permit selective access to the brew chamber. According to the illustrated embodiment, an inlet (not shown) is defined within lid 174 of brew module 170 for receiving the flow of heated water 166. In addition, a bottom of brew module defines an outlet 176 for dispensing the brewed beverage. Alternatively, dispenser 144 may dispense water for other purposes directly through a dedicated hot water outlet nozzle or discharge line (e.g., such as hot water outlet 154).

Referring again to FIGS. 1 and 2, refrigerator appliance 100 may include a control panel 180 including one or more selector inputs 182, such as knobs, buttons, touchscreen interfaces, etc. Additionally, a display 184, such as an indicator light or a screen, may be provided on control panel 180. According to still other embodiments, selector inputs 182 and display 184 may be merged as a single touch screen interface. During operation, control panel 180 may be provided for controlling the mode of operation of dispenser 144, e.g., for selecting chilled liquid water, heated liquid water, crushed ice, and/or whole ice. Selector inputs 182 can include a chilled water dispensing button (not labeled), an ice-dispensing button (not labeled) and a heated water dispensing button (not labeled) for selecting between chilled liquid water, ice and heated liquid water, respectively.

Control panel 180, selector inputs 182, and display 184 may be in communication with a processing device or controller 186. In this manner, controller 186 may receive control inputs from selector inputs 182, may display information using display 184, and may otherwise regulate operation of the appliance. For example, signals generated in controller 186 may operate refrigerator appliance 100, including climate control system 50 and other system components, in response to the position of selector inputs 182 and other control commands.

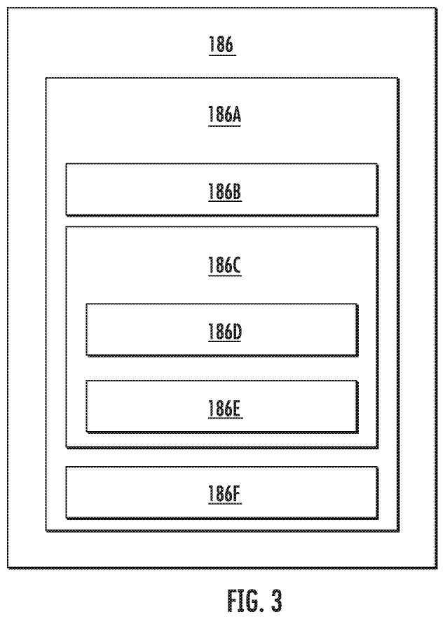

FIG. 3 depicts certain components of controller 186 according to example embodiments of the present disclosure. Controller 186 can include one or more computing device(s) 186A which may be used to implement methods as described herein. Computing device(s) 186A can include one or more processor(s) 186B and one or more memory device(s) 186C. The one or more processor(s) 186B can include any suitable processing device, such as a microprocessor, microcontroller, integrated circuit, an application specific integrated circuit (ASIC), a digital signal processor (DSP), a field-programmable gate array (FPGA), logic device, one or more central processing units (CPUs), graphics processing units (GPUs) (e.g., dedicated to efficiently rendering images), processing units performing other specialized calculations, etc. The memory device(s) 186C can include one or more non-transitory computer-readable storage medium(s), such as RAM, ROM, EEPROM, EPROM, flash memory devices, magnetic disks, etc., and/or combinations thereof.

The memory device(s) 186C can include one or more computer-readable media and can store information accessible by the one or more processor(s) 186B, including instructions 186D that can be executed by the one or more processor(s) 186B. For instance, the memory device(s) 186C can store instructions 186D for running one or more software applications, displaying a user interface, receiving user input, processing user input, etc. In some implementations, the instructions 186D can be executed by the one or more processor(s) 186B to cause the one or more processor(s) 186B to perform operations, e.g., such as one or more portions of methods described herein. The instructions 186D can be software written in any suitable programming language or can be implemented in hardware. Additionally, and/or alternatively, the instructions 186D can be executed in logically and/or virtually separate threads on processor(s) 186B.

The one or more memory device(s) 186C can also store data 186E that can be retrieved, manipulated, created, or stored by the one or more processor(s) 186B. The data 186E can include, for instance, data to facilitate performance of methods described herein. The data 186E can be stored in one or more database(s). The one or more database(s) can be connected to controller 186 by a high bandwidth LAN or WAN, or can also be connected to controller through network(s) (such as network 194 described below). The one or more database(s) can be split up so that they are located in multiple locales. In some implementations, the data 186E can be received from another device.

The computing device(s) 186A can also include a communication module or interface 186F used to communicate with one or more other component(s) of controller 186 or refrigerator appliance 100 over the network(s). The communication interface 186F can include any suitable components for interfacing with one or more network(s), including for example, transmitters, receivers, ports, controllers, antennas, or other suitable components.

As illustrated and described in FIG. 3, controller 186 includes a memory and microprocessor, such as a general or special purpose microprocessor operable to execute programming instructions or micro-control code associated with methods described herein. However, it should be appreciated that according to alternative embodiments, controller 186 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Selector inputs 182, display 184, sensors, and other components of refrigerator appliance 100 may be in communication with controller 186 via one or more signal lines or shared communication busses.

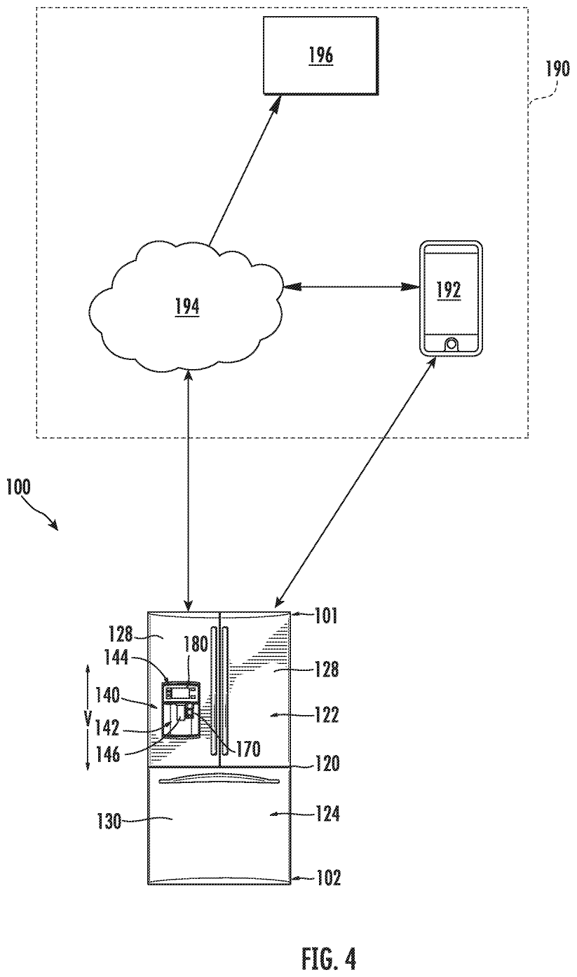

Referring now specifically to FIG. 4, a schematic diagram of an external communication system 190 will be described according to an exemplary embodiment of the present subject matter. In general, external communication system 190 is configured for enabling communication between a user, an appliance, and a remote server. Specifically, according to the illustrated embodiment, refrigerator appliance 100 may communicate with a remote device 192 either directly (e.g., via WiFi, Bluetooth, etc.) or indirectly (e.g., via a network 194), as well as with a remote server 196 (e.g., via network 194). In addition, or alternatively, communication between the appliance and the user may be achieved directly through an appliance control panel (e.g., control panel 180). Each of these subsystems and the operation will be described below according to an exemplary embodiment of the present subject matter.

As illustrated, external communication system 190 permits controller 186 of refrigerator appliance 100 to communicate with external devices either directly or through a network 194. For example, a consumer may use a remote device 192 to communicate directly with refrigerator appliance 100. For example, remote devices 192 may be in direct or indirect communication with refrigerator appliance 100, e.g., directly through a local area network (LAN), Wi-Fi, Bluetooth, etc. or indirectly through network 194. In general, remote device 192 may be any suitable device for providing and/or receiving communications or commands from a user. In this regard, remote device 192 may include, for example, a personal phone, a tablet, a laptop computer, or another mobile device.

In addition, a remote server 196 may be in communication with refrigerator appliance 100 and/or remote device 192 through network 194. In this regard, for example, remote server 196 may be configured for sending and receiving data from refrigerator appliance 100 or user (e.g., via remote device 192), as described in detail below. In this regard, remote server 196 may be a cloud-based server 196, and is thus located at a distant location, such as in a separate state, country, etc. In general, communication between the remote server 196 and the client devices may be carried via a network interface using any type of wireless connection, using a variety of communication protocols (e.g. TCP/IP, HTTP, SMTP, FTP), encodings or formats (e.g. HTML, XML), and/or protection schemes (e.g. VPN, secure HTTP, SSL).

In general, network 194 can be any type of communication network. For example, network 194 can include one or more of a wireless network, a wired network, a personal area network, a local area network, a wide area network, the internet, a cellular network, etc. According to an exemplary embodiment, remote device 192 may communicate with a remote server 196 over network 194, such as the internet, to receive notifications, provide confirmations, input operational data, etc. In addition, remote device 192 and remote server 196 may communicate with refrigerator appliance 100 confirm routine events and initiation operating cycles, as described in detail below.

External communication system 190 is described herein according to an exemplary embodiment of the present subject matter. However, it should be appreciated that the exemplary functions and configurations of external communication system 190 provided herein are used only as examples to facilitate description of aspects of the present subject matter. System configurations may vary, other communication devices may be used to communicate directly or indirectly with one or more appliances, other communication protocols and steps may be implemented, etc. These variations and modifications are contemplated as within the scope of the present subject matter. Moreover, although the discussion herein describes using external communication system 190 for perform a particular routine event of a refrigerator appliance, it should be appreciated that aspects of the present subject matter may be used to identify and initiate any other routine events for a refrigerator or any other suitable appliance.

Now that the construction and configuration of refrigerator appliance 100 and external communication system 190 have been presented according to an exemplary embodiment of the present subject matter, an exemplary method 200 for operating an appliance using an external communication system or remote server is provided. Method 200 can be used to operate refrigerator appliance 100 using external communication system 190, or to operate any other suitable appliance using any other suitable communication system. In this regard, for example, controller 186 may be configured for implementing method 200. However, it should be appreciated that the exemplary method 200 is discussed herein only to describe exemplary aspects of the present subject matter, and is not intended to be limiting.

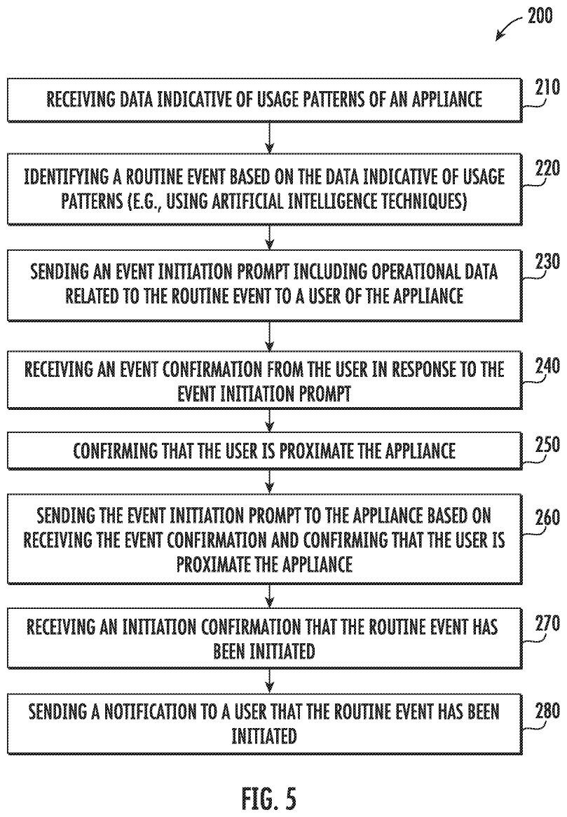

Referring now to FIG. 5, a method 200 of using a remote server to operate an appliance will be described according to an exemplary embodiment. Specifically, some or all steps of method 200 may be performed, initiated, facilitated, or otherwise involve a remote server, such as remote server 196 described above. As illustrated, method 200 includes, at step 210, receiving data indicative of usage patterns of an appliance. For example, continuing the example from above, the appliance may be refrigerator appliance 100 and the usage patterns for which data is obtained may involve the use of dispensing assembly 140 to preheat water.

Specifically, the data indicative of usage patterns may be collected by refrigerator appliance 100 and transmitted to remote server 196, e.g. using controller 186 and network 194. In general, the data may include any information related to the use of refrigerator appliance and/or habits of a user of refrigerator appliance 100. For example, the data may include days and times at which dispensing assembly 140 dispenses ice, chilled water, hot water, etc. In addition, the data indicative of usage patterns may include a volume of ice or water dispensed, the temperature of water dispensed, or any other operating characteristics of refrigerator appliance 100. Furthermore, the data indicative of usage patterns may include operating adjustments or parameter changes initiated by controller 186, inputs or feedback provided by a user, performance data, or any other suitable information.

Step 220 includes identifying a routine event based on the data indicative of usage patterns. In this regard, the data indicative of usage patterns is collected by remote server 196 and analyzed in order to identify operating characteristics, tasks, or other events performed by refrigerator appliance 100 which may be repeated in a predictable manner. Notably, according to an exemplary embodiment, the process of identifying routine events may be performed using artificial intelligence techniques. For example, the data analysis and artificial intelligence process may incorporate methods such as heuristics, support vector machines, neural networks, the Markov decision process, natural language processing, case-based reasoning, rule-based systems, genetic algorithms, fuzzy systems, multi-agent systems, or any other suitable known techniques or algorithms.

The process of identifying the routine event may generally include identifying or specifying operational data related to the performance of that event. In this regard, “operational data” may include any appliance setting, operating time, component setting, part configuration, control action, or other operating characteristic that may affect the performance of refrigerator appliance 100. Thus, for example, the operational data related to the routine event may include one or more of a day of the week and time of day during which water is dispensed, the temperature of the dispensed water, a volume of the dispensed water, etc.

After a routine event is identified at step 220, step 230 includes sending an event initiation prompt including operational data related to the routine event to a user of the appliance. In this regard, for example, remote server 196 may send a push notification to a mobile phone or other remote device 192 associated with the user. The event initiation prompt may include details regarding the routine event, a request for approval to initiate the routine event, or any other information useful to a user of the appliance.

According to the described embodiment herein, the event initiation prompt can include a notification to a user of the appliance. However, according to alternative embodiments, the user may be able to communicate directly or indirectly with the appliance to modify the requested event based on the notification, choose options related to the event, etc. For example, if a user typically drinks coffee every weekday morning at 8:00 AM and prefers an optimal water temperature of 165° F., the notification may include such information. However, if the user wakes up one morning to the notification and prefers hot chocolate at a different temperature, e.g., 150° F., the user could change the preheat temperature in response to the notification. Furthermore, other operational parameters may be modified when desired.

Step 240 includes receiving an event confirmation from the user in response to the event initiation prompt sent at step 230. In this regard, upon receiving the event initiation prompt, the user of the appliance may decide whether or not they would like to proceed with initiating the routine event. If the user wishes to continue with the routine event, they may communicate the event confirmation either directly to the refrigerator appliance or back to remote server 196.

Notably, it may frequently be desirable to determine whether a user is near the appliance before sending an event initiation prompt. Thus, step 250 includes confirming that the user is proximate the appliance. As used herein, a user is “proximate” to the appliance if it is reasonably likely that they will use the appliance shortly after the routine event is performed, e.g., the user is present within the residence where the appliance is located. The proximity of the user may be determined in any suitable manner. For example, the proximity of the user may be determined using a global positioning system (GPS) within a mobile device of the user, or any other suitable remote device 192. In addition, according to exemplary embodiments, remote server 196 may be in communication with a security system for receiving feedback and detecting proximity using proximity sensors, cameras, or other detection systems positioned within the residence where the appliance is located. Other methods of confirming user proximity are contemplated as within the scope of the present subject matter.

Although steps 240 and 250 described above involve obtaining approval of the user to initiate a routine event and confirming that that user is near the appliance, it should be appreciated that according to alternative embodiments these steps may be omitted. In this regard, for example, step 230 could alternatively include sending the event initiation prompt directly to the appliance, which could then initiate routine event without seeking approval or otherwise communicating directly with the user of the appliance regarding the initiation of the routine event.

Step 260 includes sending the event initiation prompt to the appliance based on receiving the event confirmation (e.g., at step 240) and confirming that the user is proximate the appliance (e.g., at step 250). In this regard, if a user is near the appliance and confirms the initiation of the routine event, the appliance may proceed, based on the operational data obtained, to initiate the routine event. For example, a user may receive a notification shortly before a time when they routinely dispense hot water to make oatmeal. The user may confirm the desire to make oatmeal, and refrigerator appliance 100 may begin heating water for use such that the desired amount of water is heated to the desired temperature by the desired time.

Step 270 includes receiving an initiation confirmation that the routine event has been initiated. For example, refrigerator appliance 100 may send remote server 196 an initiation confirmation after the water heating process has commenced. Step 280 includes sending a notification to a user that the routine event has been initiated. Thus, for example, after remote server 196 receives the initiation confirmation, it may send a push notification to remote device 192 of user to inform the user that the water heating process has begun. Alternatively, refrigerator appliance 100 may send a notification directly to the user, e.g., to the user's remote device 192 via Wi-Fi or Bluetooth communication.

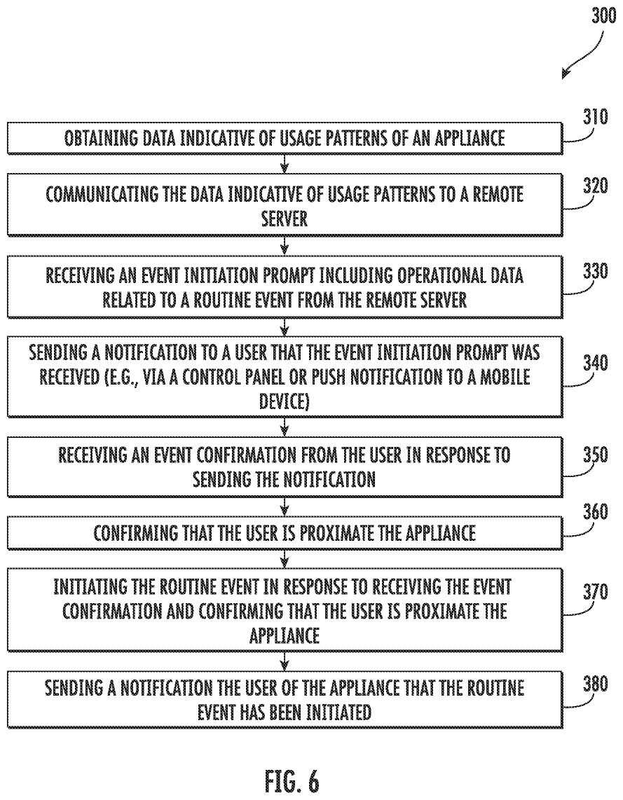

Referring now to FIG. 6, a method 300 of operating an appliance will be described according to an exemplary embodiment. Specifically, some or all steps of method 300 may be performed, initiated, facilitated, or otherwise involve an appliance, such as refrigerator appliance 100 described above. Notably, many aspects of method 300 are similar to those of method 200. Therefore, similar aspects between the two methods may be omitted herein for brevity.

As illustrated, method 300 includes, at step 310, obtaining data indicative of usage patterns of an appliance. For example, controller 186 of refrigerator appliance 100 may measure, collect, or otherwise obtain usage data (e.g., as defined generally above) during normal operation. Step 320 includes communicating the data indicative of usage patterns to a remote server. In this regard, for example, refrigerator appliance 100 may communicate the data indicative of usage patterns to remote server 196 through network 194.

Step 330 includes receiving an event initiation prompt including operational data related to a routine event from the remote server. In this regard, as described briefly above, remote server 196 may be configured for analyzing data using artificial intelligence or other techniques in order to identify routine events and ascertaining the associated operational data necessary to perform such routine events. Once a routine event is identified, remote server 196 may send an event initiation prompt which is received by refrigerator appliance 100 at step 330.

Step 340 includes sending a notification to a user that the event initiation prompt was received. For example, refrigerator appliance 100 may send the notification to a user using control panel 180, e.g., using display 184 or a speaker for generating an audible output. Alternatively, the user's remote device 192 may receive the notification directly from refrigerator appliance 100 or indirectly through network 194 or from remote server 196.

Similar to steps 240 and 250 described above, steps 350 and 360 of method 300 include receiving an event confirmation from the user in response to sending the notification and confirming that the user is proximate the appliance. Step 370 includes initiating the routine event in response to receiving the event confirmation and confirming that the user is proximate the appliance. In addition, step 380 may include sending a notification to the user appliance that the routine event has been initiated.

FIGS. 5 and 6 depict exemplary control methods having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of the methods are explained using refrigerator appliance 100 and external communication system 190 as an example, it should be appreciated that these methods may be applied to the operation of any suitable appliance for performing any suitable task, routine, or operating cycle.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of using a remote server to operate an appliance, the method comprising:
receiving data indicative of usage patterns of the appliance;
identifying a routine event based on the data indicative of usage patterns; and
sending an event initiation prompt including operational data related to the routine event to the appliance or a user of the appliance.

2. The method of claim 1, wherein identifying the routine event comprises:
using artificial intelligence techniques to analyze the data indicative of usage patterns.

3. The method of claim 1, wherein the event initiation prompt is sent to the user of the appliance, the method further comprising:
receiving an event confirmation from the user in response to the event initiation prompt; and
sending the event initiation prompt to the appliance based on receiving the event confirmation.

4. The method of claim 1, wherein the event initiation prompt is sent to the appliance, the method further comprising:
receiving an initiation confirmation that the routine event has been initiated; and
sending a notification to a user that the routine event has been initiated.

5. The method of claim 4, wherein sending the notification to the user comprises:
sending a push notification to a mobile device.

6. The method of claim 1, further comprising:
confirming that the user is proximate the appliance; and
sending the event initiation prompt only if the user is proximate the appliance.

7. The method of claim 6, wherein confirming that the user is proximate the appliance comprises:
using a global positioning system on a mobile device.

8. The method of claim 1, wherein the appliance is a refrigerator appliance, and wherein the routine event involves using a dispensing assembly of the refrigerator appliance to preheat hot water.

9. The method of claim 8, wherein the operational data related to the routine event comprises at least one of a day of the week, a time of day, a temperature of dispensed water, and a volume of the dispensed water.

10. A method of operating an appliance, the method comprising:
obtaining data indicative of usage patterns of the appliance;
communicating the data indicative of usage patterns to a remote server;
receiving an event initiation prompt including operational data related to a routine event from the remote server or a user of the appliance; and
initiating the routine event in response to receiving the event initiation prompt.

11. The method of claim 10, wherein the routine event is identified on the remote server using artificial intelligence techniques.

12. The method of claim 10, further comprising:
sending a notification to a user that the event initiation prompt was received; and
receiving an event confirmation from the user in response to sending the notification, and wherein the routine event is initiated only if the event confirmation is received.

13. The method of claim 12, wherein sending the notification to the user comprises:
providing a notification through a control panel on the refrigerator appliance.

14. The method of claim 12, wherein sending the notification to the user comprises:
sending a push indication to a mobile device.

15. The method of claim 10, further comprising:
sending a notification the user of the appliance that the routine event has been initiated.

16. The method of claim 10, further comprising:
confirming that the user is proximate the appliance; and
initiating the routine event only if the user is proximate the appliance.

17. The method of claim 16, wherein confirming that the user is proximate the appliance comprises:
using a global positioning system on a mobile device.

18. The method of claim 10, wherein the appliance is a refrigerator appliance, wherein the routine event involves using a dispensing assembly of the refrigerator appliance to preheat hot water, and wherein the operational data related to the routine event comprises at least one of a day of the week, a time of day, a temperature of dispensed water, and a volume of the dispensed water.

19. A refrigerator appliance, comprising:
a cabinet defining a chilled chamber;
a door being rotatably hinged to the cabinet to provide selective access to the chilled chamber, the door defining a dispenser recess;
a dispensing assembly positioned within the dispenser recess for providing a flow of water and a heating assembly for heating the flow of water; and
a controller operably coupled to the dispensing assembly, the controller being configured for:
obtaining data indicative of usage patterns of the dispensing assembly of the refrigerator appliance;
communicating the data indicative of usage patterns to a remote server;
receiving an event initiation prompt including operational data related to a routine event of the dispensing assembly; and
initiating the routine event in response to receiving the event initiation prompt.

20. The refrigerator appliance of claim 19, wherein the controller is further configured for:
sending a notification to a user that the event initiation prompt was received; and
receiving an event confirmation from the user in response to sending the notification, and wherein the routine event is initiated only if the event confirmation is received.
